(19) United States
(12) Patent Application Publication
(10) Pub. No.: US 2025/0211068 A1
(43) Pub. Date: Jun. 26, 2025

(54) Stator of Rotary Electric Machine

(71) Applicant: Hitachi Astemo, Ltd., Hitachinaka-shi, Ibaraki (JP)

(72) Inventors: Keisuke TATENO, Hitachinaka-shi, Ibaraki (JP); Yuichiro BABA, Hitachinaka-shi, Ibaraki (JP); Hiroshi AOKI, Hitachinaka-shi, Ibaraki (JP)

(21) Appl. No.: 18/848,960

(22) PCT Filed: Jun. 30, 2022
(86) PCT No.: PCT/JP2022/026367

§ 371 Date: Sep. 20, 2024

(51) Int. Cl. H02K 11/25; H02K 1/16

(52) U.S. Cl. CPC H02K 11/25; H02K 1/16; H02K 2203/09

(57) ABSTRACT

A stator of a rotary electric machine includes an annular stator core having a slot, a slot conductor disposed in the slot, a coil end conductor that is disposed outside the slot and connected to the slot conductor, a temperature detector attached to the coil end conductor, and an attachment member that fixes the temperature detector to the coil end conductor. The attachment member includes a base portion that forms a mounting region in which the temperature detector is disposed, a first biasing portion that biases the temperature detector to the base portion side, a first connection portion that connects one end of the base portion and the first biasing portion, a second biasing portion that biases the coil end conductor to the base portion side, and a second connection portion that connects the other end of the base portion and the second biasing portion.

### TECHNICAL FIELD

The present invention relates to a stator of a rotary electric machine.

### BACKGROUND ART

Rotary electric machines are used in various technical fields. PTL 1 discloses a stator of a rotary electric machine including a stator core, a stator winding mounted on the stator core, a temperature sensor, and a temperature sensor holder that sandwiches the temperature sensor and a stator winding portion in a coil end that is a portion of the stator winding protruding from both ends of the stator core, in which the temperature sensor holder deformable in a direction other than a sandwiching direction in addition to the sandwiching direction.

### CITATION LIST

### Patent Literature

PTL 1: WO 2019/087568 A

### SUMMARY OF INVENTION

### Technical Problem

In the invention disclosed in PTL 1, there is room for improvement in assemblability.

### Solution to Problem

According to a first aspect of the present invention, a stator of a rotary electric machine includes an annular stator core having a slot, a slot conductor disposed in the slot, a coil end conductor that is disposed outside the slot and connected to the slot conductor, a temperature detector attached to the coil end conductor, and an attachment member that fixes the temperature detector to the coil end conductor. The attachment member includes a base portion that forms a mounting region in which the temperature detector is disposed, a first biasing portion that biases the temperature detector to the base portion side, a first connection portion that connects one end of the base portion and the first biasing portion, a second biasing portion that biases the coil end conductor to the base portion side, and a second connection portion that connects the other end of the base portion and the second biasing portion.

### Advantageous Effects of Invention

According to the present invention, it is possible to provide a stator of a rotary electric machine having excellent assemblability.

### BRIEF DESCRIPTION OF DRAWINGS

FIG. 1 is an external view of a stator.

FIG. 2 is an enlarged view of a temperature detector and an attachment member.

FIG. 3 is a perspective view of the attachment member.

FIG. 4 is a side view of the attachment member.

FIG. 5 is a cross-sectional view taken along line

V-V of FIG. 4.

FIG. 6 is a view illustrating a shape of a first biasing portion.

FIG. 7 is a view for explaining assembly of a comparative stator.

FIG. 8 is a view illustrating a configuration of a first biasing portion in Modification Example 3.

### DESCRIPTION OF EMBODIMENTS

### First Embodiment

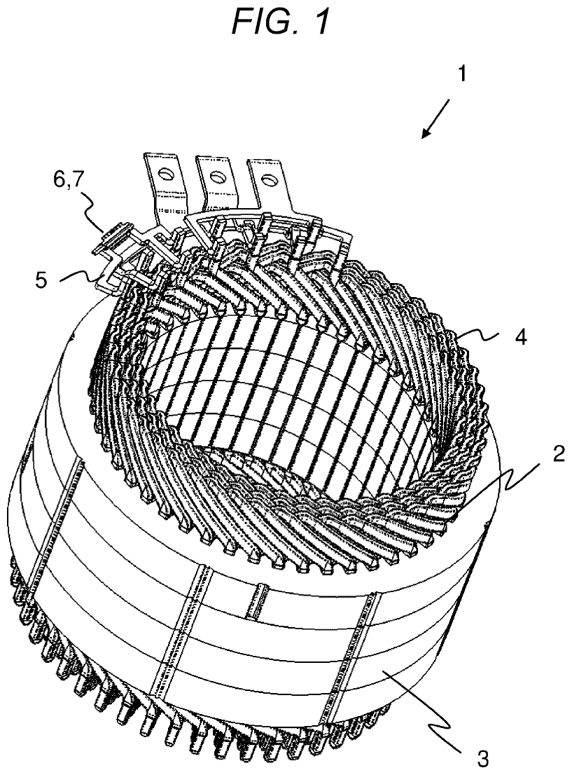

Hereinafter, a first embodiment of a stator of a rotary electric machine will be described with reference to FIGS. 1 to 7.

FIG. 1 is an external view of a stator 1. The stator 1 constitutes a rotary electric machine together with a rotor (not illustrated). The stator 1 includes an annular stator core 3 having a slot 2, a slot conductor 4 disposed inside the slot 2, a coil end conductor 5A, a bus bar 5B, a temperature detector 6, and an attachment member 7. The bus bar 5B connects the coil end conductors 5A to each other and is indirectly connected to the slot conductor 4. However, in FIG. 1, the temperature detector 6 and the attachment member 7 are substantially integrally displayed depending on the scale. The coil end conductor 5A is disposed outside the slot 2 and is directly connected to the slot conductor 4. The temperature detector 6 is attached to the bus bar 5B to detect the temperature of the bus bar 5B. The attachment member 7 fixes the temperature detector 6 to the bus bar 5B.

Note that the temperature detector 6 may be attached to the coil end conductor 5A to detect the temperature of the coil end conductor 5A. Further, the temperature detector 6 may be attached to a neutral line connecting the coil end conductors 5A to detect the temperature of the neutral line. The coil end conductor 5A, the bus bar 5B, and the neutral line are collectively referred to as a “connection conductor” 5 below.

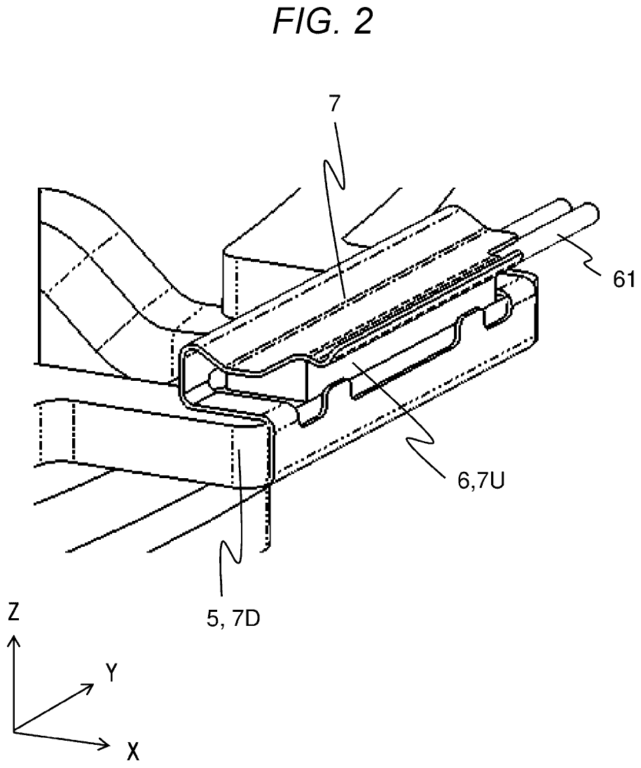

FIG. 2 is an enlarged view of the temperature detector 6 and the attachment member 7. FIG. 2 illustrates XYZ axes perpendicular to each other for description. The temperature detector 6 has, for example, a rectangular parallelepiped shape, and the longitudinal direction of the temperature detector 6 is parallel to the Y-axis in FIG. 2. Further, the temperature detector 6 has a signal line 61 extending in the positive direction of the Y-axis. The attachment member 7 has an S-shaped cross section in the XZ plane, and forms a first mounting region 7U in the positive direction of the Z-axis and a second mounting region 7D in the negative direction of the Z-axis in

FIG. 2. The temperature detector 6 is mounted on the first mounting region 7U, and the connection conductor 5 is mounted on the second mounting region 7D.

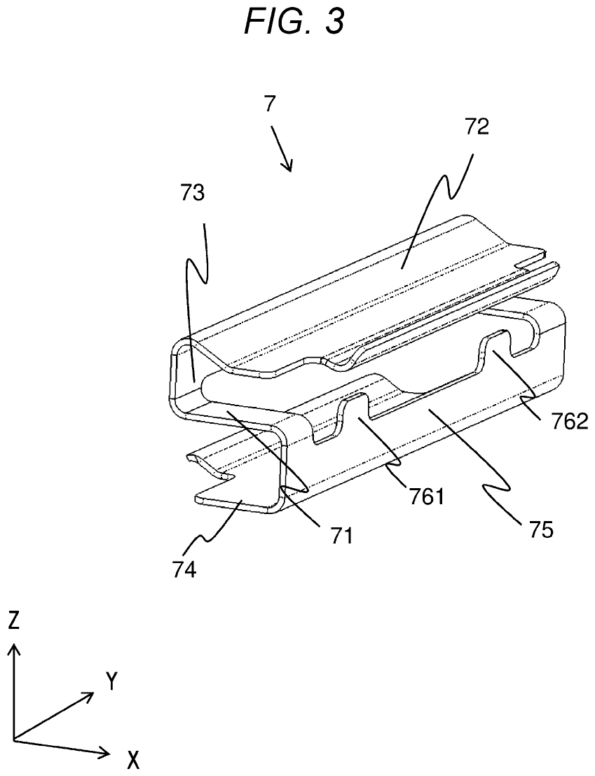

FIG. 3 is a perspective view of the attachment member 7, and the posture of the attachment member 7 coincides with that of FIG. 2. In other words, FIG. 3 is a view in which the connection conductor 5 and the temperature detector 6 are removed from FIG. 2. The attachment member 7 includes a base portion 71, a first biasing portion 72, a first connection portion 73, a second biasing portion 74, a second connection portion 75, a first protrusion portion 761, and a second protrusion portion 762.

The base portion 71 forms the first mounting region 7U in which the temperature detector 6 is disposed. The first biasing portion 72 biases the temperature detector 6 to the base portion 71 side. The first connection portion 73 connects one end of the base portion 71 and the first biasing portion 72. The second biasing portion 74 biases the connection conductor 5 to the base portion 71 side. The second connection portion 75 connects the other end of the base portion 71 and the second biasing portion 74. The first protrusion portion 761 and the second protrusion portion 762 prevent falling-off of the temperature detector 6. The first protrusion portion 761 and the second protrusion portion 762 are also collectively referred to as “protrusion portions” 76 below.

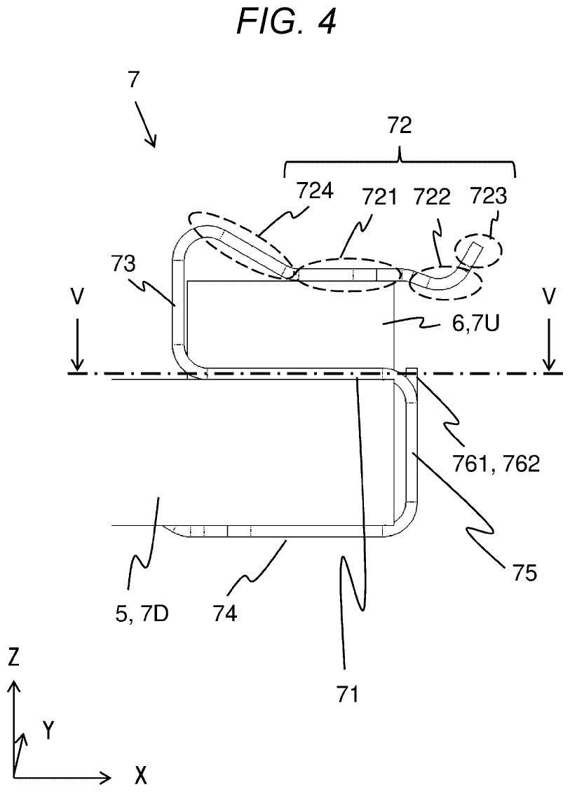

FIG. 4 is a side view of the attachment member 7. In FIG. 4, the right side in the drawing is the positive side of the X-axis, the back side in the drawing is the positive side of the Y-axis, and the upper side in the drawing is the positive side of the Z-axis. The first biasing portion 72 includes a first biasing contact portion 721, a first biasing protrusion portion 722, a first biasing introduction portion 723, and a first biasing non-contact portion 724. The first biasing contact portion 721 is a part of the first biasing portion 72 that comes into contact with the temperature detector 6. The first biasing protrusion portion 722 is a part of the first biasing portion 72 that is located on the positive side of the X-axis with respect to the first biasing contact portion 721 and is located on the negative side of the Z-axis with respect to the first biasing contact portion 721. The first biasing introduction portion 723 is a part of the first biasing portion 72 that is located on the positive side of the X-axis with respect to the first biasing contact portion 721 and has a position on the Z-axis that is equal to or higher than that of the first biasing contact portion 721. The first biasing non-contact portion 724 is a part of the first biasing portion 72 that is located on the negative side of the X-axis with respect to the first biasing contact portion 721 and is not in contact with the temperature detector 6.

A space surrounded by the base portion 71, the first biasing portion 72, and the first connection portion 73 is the first mounting region 7U. To be precise, in the first mounting region 7U, the upper portion on the positive side of the X-axis is surrounded by the first biasing protrusion portion 722, and the lower portion on the positive side of the X-axis is surrounded by the first protrusion portion 761 and the second protrusion portion 762. A space surrounded by the base portion 71, the second biasing portion 74, and the second connection portion 75 is the second mounting region 7D.

The connection conductor 5 is biased to the positive side of the Z-axis by the second biasing portion 74, and comes into contact with the base portion 71 on the surface of the base portion 71 on the positive side of the Z-axis. The temperature detector 6 is biased to the negative side of the Z-axis by the first biasing portion 72. The temperature detector 6 is not in contact with the base portion 71 even on the surface of the base portion 71 on the positive side of the Z-axis, and is not in contact with the base portion 71 even on the surface of the base portion 71 on the negative side of the Z-axis. The surface of the temperature detector 6 on the negative side of the Z-axis is in contact with the surface of the connection conductor 5 on the positive side of the Z-axis. That is, the connection conductor 5 and the temperature detector 6 are in direct contact with each other. The force for maintaining the contact between the connection conductor 5 and the temperature detector 6 is an elastic force of the first biasing portion 72 and the second biasing portion 74.

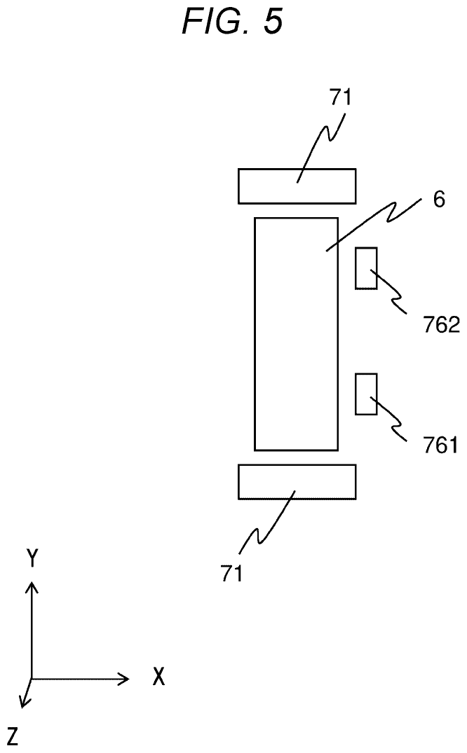

FIG. 5 is a cross-sectional view taken along line V-V in FIG. 4, and illustrates the temperature detector 6 and the attachment member 7. In FIG. 5, the right side in the drawing is the positive side of the X-axis, the upper side in the drawing is the positive side of the Y-axis, and the front side in the drawing is the positive side of the Z-axis. The base portion 71 is hollowed out at the center in the Y-axis direction, and the temperature detector 6 is disposed therein. The temperature detector 6 and the attachment member 7 do not overlap each other in the Z-axis direction. That is, the movement of the temperature detector 6 to the positive side and the negative side of the Y-axis is restrained by the base portion 71. Note that, in FIG. 5, a gap exists in each of the temperature detector 6 and the two base portions 71, but a gap may exist only in one of the temperature detector 6 and the two base portions 71.

Since the first protrusion portion 761 and the second protrusion portion 762 are disposed on the positive side in the X-axis direction of the temperature detector 6, the movement of the temperature detector 6 to the positive side in the X-axis direction is restrained. Note that, in the cross section on the positive side of the Z-axis side with respect to the position illustrated in FIG. 5, since the first connection portion 73 exists on the negative side in the X-axis direction of the temperature detector 6, the movement of the temperature detector 6 to the negative side in the X-axis direction is also restrained.

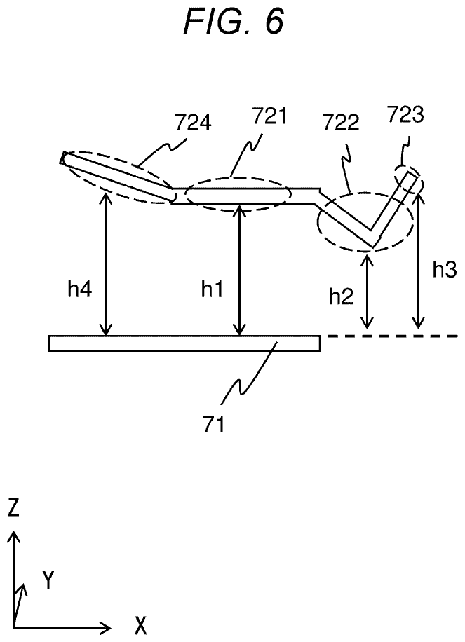

FIG. 6 is a view illustrating the shape of the first biasing portion 72. However, the broken line in FIG. 6 indicates the position of the surface of the base portion 71 on the positive side of the Z-axis. The lengths of the first biasing contact portion 721, the first biasing protrusion portion 722, the first biasing introduction portion 723, and the first biasing non-contact portion 724 from the surface of the base portion 71 on the positive side of the Z-axis are set as h1, h2, h3, and h4. In this case, the length h2 is shorter than the length h1, the length h3 is equal to or longer than the length h1, and the length h4 is longer than the length h1.

### (Assembling Method)

An assembling method of attaching the temperature detector 6 to the connection conductor 5 by using the attachment member 7 will be described. Note that, here, an assembling method will be described on the assumption that the connection conductor 5 having a heavy weight is not moved, but the assembling method of moving the connection conductor 5 is not excluded. For example, first, the attachment member 7 is moved from the positive side to the negative side of the X-axis with respect to the connection conductor 5, and the connection conductor 5 is fitted into the second mounting region 7D. Then, with respect to the attachment member 7 integrated with the connection conductor 5, the temperature detector 6 is moved from the positive side to the negative side of the X-axis and fitted into the first mounting region 7U. Note that, at this time, the longitudinal direction of the temperature detector 6 is inclined with respect to the Y-axis such that the first protrusion portion 761 and the second protrusion portion 762 do not hinder the movement of the temperature detector 6.

When the temperature detector 6 is attached to the attachment member 7, it is desirable to push the temperature detector 6 to a position in contact with the first connection portion 73 existing at the innermost side of the first mounting region 7U, that is, on the negative side of the X-axis for the purpose of ensuring the attachment. At this time, when the temperature detector 6 abuts against the first connection portion 73, the entirety of the attachment member 7 receives a force on the negative side of the X-axis, and the second connection portion 75 is pressed against the connection conductor 5 by this force. Therefore, it can be said that fine force adjustment is unnecessary as long as the force does not cause deformation or breakage of the attachment member 7, and the stator 1 is excellent in assemblability.

### COMPARATIVE EXAMPLE

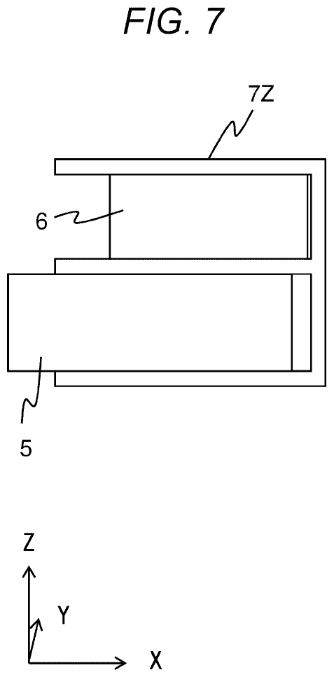

Assembly of a comparative stator 1Z including a comparative attachment member 7Z will be described for comparison with the stator 1 in the present embodiment with reference to FIG. 7. The connection conductor 5 and the temperature detector 6 are inserted into the comparative attachment member 7Z from the same direction. In the example illustrated in FIG. 7, the connection conductor 5 and the temperature detector 6 are inserted into the comparative attachment member 7Z from the negative side to the positive side of the X-axis. In this comparative example, there is a problem that insertion of the member inserted earlier becomes easier due to the member inserted later. A specific description will be given with an example.

For example, a case where the comparative attachment member 7Z is first attached to the connection conductor 5, and then the temperature detector 6 is inserted into the comparative attachment member 7Z will be considered. In this case, when the temperature detector 6 is pressed against the wall surface of the comparative attachment member 7Z on the positive side of the X-axis, the comparative attachment member 7Z may move to the positive side of the X-axis and fall off from the connection conductor 5. For example, by a countermeasure such as fixing the position of the end surface of the comparative attachment member 7Z on the positive side of the X-axis, it is possible to prevent an occurrence of the problem that the insertion of the member inserted earlier becomes easier due to the member inserted later, but it not possible to be denied that the deterioration of the assemblability is caused due to the presence of matters to be considered at the time of assembling.

According to the first embodiment described above, the following operational effects can be obtained.
(1) The stator 1 includes the annular stator core having the slot 2, a slot conductor 4 disposed in the slot 2, the connection conductor 5 that is disposed outside the slot 2 and connected to the slot conductor 4, the temperature detector 6 attached to the connection conductor 5, and an attachment member 7 that fixes the temperature detector 6 to the connection conductor 5. The attachment member 7 includes the base portion 71 that forms the first mounting region 7U in which the temperature detector 6 is disposed, the first biasing portion 72 that biases the temperature detector 6 to the base portion 71 side, the first connection portion 73 that connects one end of the base portion and the first biasing portion 72, the second biasing portion 74 that biases the connection conductor 5 to the base portion 71 side, and the second connection portion 75 that connects the other end of the base portion 71 and the second biasing portion 74. Therefore, since the attachment direction of the attachment member 7 to the connection conductor 5 coincides with the attachment direction of the temperature detector 6 to the attachment member 7, one of the attachment member 7 and the temperature detector 6 does not fall off without adjusting the degree of an insertion force or the like, and thus excellent assemblability is obtained.
(2) As illustrated in FIG. 3, the center of the base portion 71 is hollowed out, and the temperature detector 6 and the connection conductor 5 are in direct contact with each other. Therefore, the measurement accuracy of the temperature by the temperature detector 6 is improved.
(3) The second connection portion 75 includes the protrusion portion 76 surrounding the first mounting region 7U. Therefore, the falling-off of the temperature detector 6 is prevented.
(4) The first biasing portion 72 includes the first biasing protrusion portion 722 surrounding the first mounting region 7U. Therefore, the falling-off of the temperature detector 6 is prevented.
(5) The first biasing portion 72 and the second biasing portion 74 are leaf springs. Therefore, since the attachment member 7 can be manufactured at low cost, the stator 1 including the attachment member 7 can also be manufactured at low cost.
(6) The connection conductor 5 is the coil end conductor 5A directly connected to the slot conductor 4, or the bus bar 5B or the neutral line further connected to the coil end conductor 5A. Therefore, the attachment member 7 may be connected to any of the coil end conductor 5A, the bus bar 5B, and the neutral line.

### Modification Example 1

In the above-described embodiment, the center of the base portion 71 is hollowed out, and the temperature detector 6 and the connection conductor 5 are in direct contact with each other. However, the base portion 71 may have a flat plate shape with no punching, and the temperature detector 6 and the connection conductor 5 does not need to be in direct contact with each other. In this case, the temperature detector 6 and the connection conductor 5 are disposed to face each other with the base portion 71 interposed therebetween.

### Modification Example 2

In the above-described embodiment, the second connection portion 75 includes the protrusion portion 76 surrounding the first mounting region 7U, and the first biasing portion 72 includes the first biasing protrusion portion 722 surrounding the first mounting region 7U. However, the first biasing portion 72 does not need to include at least one of the protrusion portion 76 and the first biasing protrusion portion 722.

### Modification Example 3

In the above-described embodiment, the first biasing portion 72 and the second biasing portion 74 are leaf springs. However, at least one of the first biasing portion 72 and the second biasing portion 74 does not need to be a leaf spring. In other words, the first biasing portion 72 and the second biasing portion 74 may include biasing means other than the leaf spring.

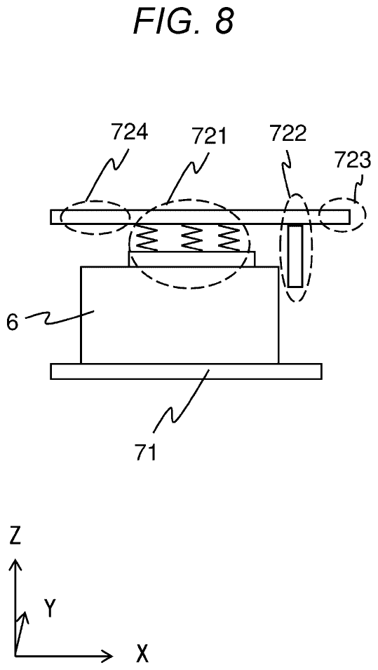

FIG. 8 is a view illustrating a configuration of the first biasing portion 72 in Modification Example 3. In the present modification example, the first biasing portion 72 is configured by a combination of a plurality of flat plates and a coil spring. Specifically, the first biasing contact portion 721 is configured to include a coil spring, and the first biasing portion 72 biases the temperature detector 6 by the elastic force of the coil spring. The first biasing protrusion portion 722 may be a flat plate separately provided.

In the above-described embodiment and modification examples, the configuration of the functional block is merely an example. Some functional configurations illustrated as separate functional blocks may be integrally configured, or a configuration illustrated in one functional block diagram may be divided into two or more functions. In addition, some of the functions of each functional block may be included in another functional block.

The above-described embodiment and modification examples may be combined. Although various embodiments and modification examples have been described above, the present invention is not limited to these contents. Other aspects conceivable within the scope of the technical idea of the present invention are also included within the scope of the present invention.

### REFERENCE SIGNS LIST

1 stator
2 slot
3 stator core
4 slot conductor
5 coil end conductor
6 temperature detector
7 attachment member
7D second mounting region
7U first mounting region
71 base portion
72 first biasing portion
721 first biasing contact portion
722 first biasing protrusion portion
723 first biasing introduction portion
724 first biasing non-contact portion
73 first connection portion
74 second biasing portion
75 second connection portion
76 protrusion portion
761 first protrusion portion
762 second protrusion portion

1. A stator of a rotary electric machine, the stator comprising:
an annular stator core having a slot;
a slot conductor disposed in the slot;
a connection conductor that is disposed outside the slot and connected to the slot conductor;
a temperature detector attached to the connection conductor; and
an attachment member that fixes the temperature detector to the connection conductor,
wherein the attachment member includes
a base portion that forms a mounting region in which the temperature detector is disposed,
a first biasing portion that biases the temperature detector to the base portion side,
a first connection portion that connects one end of the base portion and the first biasing portion,
a second biasing portion that biases the connection conductor to the base portion side, and
a second connection portion that connects the other end of the base portion and the second biasing portion.

2. The stator of the rotary electric machine according to claim 1, wherein
the base portion is hollowed out, and
the temperature detector and the connection conductor are in direct contact with each other.

3. The stator of the rotary electric machine according to claim 1, wherein the second connection portion further includes a protrusion portion surrounding the mounting region.

4. The stator of the rotary electric machine according to claim 1, wherein the first biasing portion further includes a protrusion portion surrounding the mounting region.

5. The stator of the rotary electric machine according to claim 1, wherein the first biasing portion and the second biasing portion are leaf springs.

6. The stator of the rotary electric machine according to claim 1, wherein the connection conductor is a coil end conductor directly connected to the slot conductor.

7. The stator of the rotary electric machine according to claim 1, wherein the connection conductor is a bus bar or a neutral line that is further connected to a coil end conductor directly connected to the slot conductor.
